(19) United States
(12) Patent Application Publication
(10) Pub. No.: US 2011/0122025 A1
(43) Pub. Date: May 26, 2011

(54) ANTENNA ADJUSTMENT APPARATUS, ANTENNA ADJUSTMENT METHOD AND TANGIBLE MACHINE-READABLE MEDIUM THEREOF

(75) Inventors: Ting-Chieh TU, Danshui Township (TW); Yi-Heng FENG, Taichung City (TW)

(73) Assignee: Institute for Information Industry, Taipei (TW)

(21) Appl. No.: 12/701,022

(22) Filed: Feb. 5, 2010

(30) Foreign Application Priority Data
Nov. 24, 2009 (TW) 098139890

(51) Int. Cl. H04B 7/00

(52) U.S. Cl. 342/367

(57) ABSTRACT

An antenna adjustment apparatus, an antenna adjustment method and a tangible machine-readable medium thereof are provided. The antenna adjustment apparatus is electrically connected to a directional antenna and is configured to generate a signal loss value according to an environmental coordinate parameter, an antenna coordinate parameter, an excitation parameter set and an antenna structure parameter. The antenna adjustment apparatus is configured to determine whether the signal loss value meets a communication quality condition and set an excitation parameter set, which meets the communication quality condition, as an available excitation parameter set so that the antenna radiation pattern of the directional antenna may be adjusted according to the available excitation parameter set.

### PRIORITY

This application claims priority to Taiwan Patent Application No. 098139890, filed on Nov. 24, 2009, the disclosure of which is incorporated by reference herein in its entirety.

### FIELD

The present invention relates to an antenna adjustment apparatus, an antenna adjustment method and a tangible machine-readable medium thereof. Specifically, the present invention relates to an antenna adjustment apparatus, an antenna adjustment method and a tangible machine-readable medium thereof for adjusting the antenna radiation pattern of an antenna.

### BACKGROUND

Owing to advancement in wireless communication technologies, various wireless communication apparatuses such as cell phones, personal digital assistants (PDAs) and notebook computers have found wide application in people's daily life. To provide the users with better communication service quality, wireless communication service providers have deployed a lot of wireless communication equipment (e.g., base stations (BSs) in wireless communication networks) in order to obtain the optimal coverage of the wireless communication networks.

Generally, quality of service provided by base stations (BSs) forming a wireless communication network is very important for the optimal coverage of the wireless communication network. In order to improve the users' conditions of transceiving signals and reduce interference among the users, most of BSs now employ a smart array antenna as a signal transceiving medium. In more detail, an array antenna comprises a plurality of antennae, and by adjusting the feeding signals of individual antennae, the antenna radiation pattern of the array antenna may be adjusted to obtain optimal coverage of the wireless communication network. In the prior art, the manners in which the feeding signals are adjusted are mostly decided by evaluating the communication environment within a local area.

Currently, most of such evaluations on outdoor communication environments utilize statistic characteristics instead of real outdoor environment conditions. However, the statistic characteristics cannot make descriptions on particular buildings and related environment individually, so errors and uncertainties tend to arise in the communication environment evaluations; on the other hand, the prior art also evaluates outdoor communication environment by use of the ray-tracing method. However, in most of the existing ray-tracing methods, monopole or omnidirectional antennae are used as transmitting and receiving antennae while array antennae are used for most BSs, so it is impossible to take different characteristics of the different antenna arrays into account in the ray-tracing methods, thereby causing errors in the communication environment evaluation. Consequently, the existing communication environment evaluation methods fail to provide an accurate evaluation that meets the real environment conditions, making it impossible to obtain optimal coverage of individual BSs.

Accordingly, there exists a need to provide a solution that may evaluate the communication environments more accurately and provide better feeding signals to antennae of base stations so that a desirable antenna radiation pattern of the base stations and improved quality of communication service may be obtained.

### SUMMARY

An objective of particular embodiments of the present invention is to provide an antenna adjustment apparatus. The antenna adjustment apparatus is electrically connected to a directional antenna located in an environment, and comprises a storage unit and a microprocessor. The microprocessor is electrically connected to the storage unit. The storage unit is configured to store an environment coordinate parameter of the environment, a first excitation parameter set, a communication quality condition, an antenna structure parameter of the directional antenna and an antenna coordinate parameter of the directional antenna located in the environment.

The microprocessor is configured to generate a first signal loss value according to the environment coordinate parameter, the antenna coordinate parameter, the first excitation parameter set and the antenna structure parameter, determine that the first signal loss value meets the communication quality condition, and set the first excitation parameter set as an available excitation parameter set so that the antenna radiation pattern of the directional antenna may be adjusted according to the available excitation parameter set.

Another objective of particular embodiments of the present invention is to provide an antenna adjustment method for the antenna adjustment apparatus described above. The antenna adjustment apparatus is electrically connected to a directional antenna located in an environment, and comprises a storage unit and a microprocessor. The microprocessor is electrically connected to the storage unit. The storage unit is configured to store an environment coordinate parameter of the environment, a first excitation parameter set, a communication quality condition, an antenna structure parameter of the directional antenna and an antenna coordinate parameter of the directional antenna located in the environment.

The antenna adjustment method according to one example embodiment comprises the steps of: (a) enabling the microprocessor to generate a first signal loss value according to the environment coordinate parameter, the antenna coordinate parameter, the first excitation parameter set and the antenna structure parameter; (b) enabling the microprocessor to determine that the first signal loss value meets the communication quality condition; and (c) enabling the microprocessor to set the first excitation parameter set as an available excitation parameter set so that the antenna radiation pattern of the directional antenna may be adjusted according to the available excitation parameter set.

Yet a further objective of particular embodiments of the present invention is to provide a tangible machine-readable medium, which stores a program of an antenna adjustment method for us in an antenna adjustment apparatus. The antenna adjustment apparatus is electrically connected to a directional antenna located in an environment, and comprises a storage unit and a microprocessor. The microprocessor is electrically connected to the storage unit. The storage unit is configured to store an environment coordinate parameter of the environment, a first excitation parameter set, a communication quality condition, an antenna structure parameter of the directional antenna and an antenna coordinate parameter of the directional antenna located in the environment.

When being loaded into the antenna adjustment apparatus, the program executes: a code A for enabling the microprocessor to generate a first signal loss value according to the environment coordinate parameter, the antenna coordinate parameter, the first excitation parameter set and the antenna structure parameter; a code B for enabling the microprocessor to determine that the first signal loss value meets the communication quality condition; and a code C for enabling the microprocessor to set the first excitation parameter set as an available excitation parameter set so that the antenna radiation pattern of the directional antenna may be adjusted according to the available excitation parameter set.

Certain embodiments of the present invention may generate an excitation parameter set meeting a communication quality condition according to a real outdoor environment, and set the excitation parameter set as an available excitation parameter set (which may be viewed as a feeding signal) so that the antenna radiation pattern of a directional antenna may be adjusted according to the available excitation parameter set. Thereby, the present invention may provide an optimal antenna excitation parameter set for a base station, and address the drawbacks of the prior art, including inability to evaluate a real outdoor environment accurately and to provide an optimal antenna radiation pattern for a base station.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of a first example embodiment of the present invention; and

FIGS. 2A-2B are flowcharts of a second example embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following description, the present invention will be explained with reference to example embodiments thereof. However, these example embodiments are not intended to limit the present invention to any specific environment, applications or particular implementations described in these example embodiments. Therefore, description of these example embodiments is only for purpose of illustration rather than limitation. It should be appreciated that, in the following example embodiments and the attached drawings, elements unrelated to the present invention are omitted from depiction; and dimensional relationships among individual elements in the attached drawings are illustrated only for ease of understanding, but not to limit the actual scale.

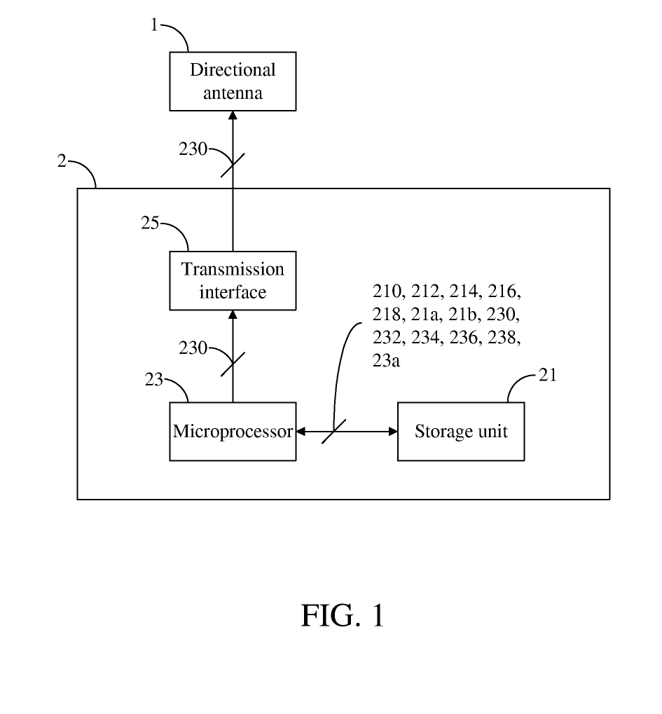

A first example embodiment of the present invention is shown in FIG. 1, which is a schematic view of an antenna adjustment system. As can be seen from FIG. 1, the antenna adjustment system comprises a directional antenna 1 and an antenna adjustment apparatus 2. The antenna adjustment apparatus 2 is electrically connected to the directional antenna 1 to transmit an available excitation parameter set 230 so that the antenna radiation pattern of the directional antenna may be adjusted according to the available excitation parameter set 230. Hereinafter, how the antenna adjustment apparatus 2 generates the available excitation parameter set 230 will be detailed.

The antenna adjustment apparatus 2 of the antenna adjustment system comprises a storage unit 21, a microprocessor 23 and a transmission interface 25. The microprocessor 23 is electrically connected to the transmission interface 25 and the storage unit 21. The transmission interface 25 is further electrically connected to the directional antenna 1 so that the microprocessor 23 is electrically connected to the directional antenna 1 via the transmission interface 25. The storage unit 21 currently stores an environment coordinate parameter 210 of an environment in which the directional antenna 1 is located, a first excitation parameter set 212, an excitation parameter set range 214, a communication quality condition 216, an antenna structure parameter 218 of the directional antenna 1, an antenna coordinate parameter 21a of the directional antenna 1 located in the environment and a predetermined signal loss value 21b.

The microprocessor 23 establishes an evaluation environment according to the environment coordinate parameter 210 and establishes an evaluation antenna in the evaluation environment according to the antenna coordinate parameter 21a and the antenna structure parameter 218. The microprocessor 23 further generates a first signal loss value 232 of the evaluation antenna in the evaluation environment by a ray-tracing method according to the first excitation parameter set 212, and determines whether the first signal loss value 232 meets the communication quality condition 216. If so, the microprocessor 23 sets the first excitation parameter set 212 as an available excitation parameter set 230 and transmits the available excitation parameter set 230 to the directional antenna 1 via the transmission interface 25 so that the antenna radiation pattern of the directional antenna 1 may be adjusted according to the available excitation parameter set 230.

Otherwise, if it is determined by the microprocessor 23 that the first signal loss value 232 does not meet the communication quality condition 216, then the microprocessor 23 chooses a second excitation parameter set 234 from the excitation parameter set range 214 according to an optimization algorithm and, according to the second excitation parameter set 234, generates a second signal loss value 236 of the evaluation antenna in the evaluation environment by the aforesaid ray-tracing method.

Next, the microprocessor 23 determines whether the second signal loss value 236 meets the communication quality condition 216. If yes, then the microprocessor 23 sets the second excitation parameter set 234 as an available excitation parameter set 230 and transmits the available excitation parameter set 230 to the directional antenna 1 via the transmission interface 25 so that the antenna radiation pattern of the directional antenna 1 may be adjusted according to the available excitation parameter set 230.

Otherwise, if it is determined by the microprocessor 23 that the second signal loss value 236 does not meet the communication quality condition 216, the aforesaid steps will be iterated by the microprocessor 23 until a signal loss value meeting the communication quality condition 216 is generated. Then, an excitation parameter set that results in the signal loss value meeting the communication quality condition 216 is set as an available excitation parameter set 230, and the available excitation parameter set 230 is transmitted to the directional antenna 1 via the transmission interface 25 so that the antenna radiation pattern of the directional antenna 1 may be adjusted according to the available excitation parameter set 230. It shall be noted that, how the microprocessor 23 iterates the aforesaid steps will be readily appreciated by those of ordinary skill in the art and, thus, will not be further described herein.

To highlight the technical characteristics of particular embodiments of the present invention, a further illustrative example is provided hereinbelow. In this example, the environment coordinate parameter 210 may be a coordinate parameter of a real outdoor environment which comprises coordinate parameters of buildings, trees, signboards or the like, so the microprocessor 23 may establish an evaluation environment substantially identical to the real outdoor environment according to the environment coordinate parameter 210. Here, the evaluation environment is a 2.5-dimensional (2.5D) environment.

The antenna coordinate parameter 21a is a position coordinate parameter of the directional antenna located in the real outdoor environment. According to the antenna coordinate parameter 21a and the antenna structure parameter 218, the microprocessor 23 establishes an evaluation antenna that is located at a proper position in the evaluation environment; in other words, in order to improve accuracy of the evaluation, the position of the evaluation antenna in the evaluation environment corresponds to that of the directional antenna in the real outdoor environment. Besides, the antenna structure parameter 218 is a structure parameter used to implement an array antenna. In this embodiment, the array antenna structure may be one of an O-shaped array antenna, a Y-shaped array antenna and an L-shaped array antenna; however, the array antenna structure may also be of other different structures in other embodiments, and this is not intended to limit the present invention.

The microprocessor 23 is further configured to generate the first signal loss value 232 of the evaluation antenna in the evaluation environment by a ray-tracing method according to the first excitation parameter set 212. Herein, the first excitation parameter set 212 at least comprises an excitation voltage and an excitation phase, the ray-tracing method is a 2.5D ray-tracing method, and the first signal loss value 232 is a path loss value or a bit error rate value. In other embodiments, the first signal loss value 232 may also be any value adapted to evaluate the extent of signal loss, and this is not intended to limit the present invention.

On the other hand, the communication quality condition 216 may be a predetermined threshold value, and the microprocessor 23 decides whether the first signal loss value 232 meets the communication quality condition 216 by determining whether the first signal loss value 232 is smaller than or equal to the predetermined threshold value. For example, if the first signal loss value 232 is a bit error rate value of 4.3 and the communication quality condition 216 is a predetermined threshold value of 5, then the microprocessor 23 determines that the first signal loss value is smaller than or equal to the predetermined threshold value, which means that the first signal loss value 232 meets the communication quality condition 216.

After determining that the first signal loss value 232 meets the communication quality condition 216, the microprocessor 23 sets the first excitation parameter set 212 as the available excitation parameter set 230 and transmits the available excitation parameter set 230 to the directional antenna 1 via the transmission interface 25 so that the antenna radiation pattern of the directional antenna 1 may be adjusted according to the available excitation parameter set 230. Specifically, the available excitation parameter set 230 may comprise an available excitation voltage and an available excitation phase. The microprocessor 23 transmits the available excitation voltage and the available excitation phase via the transmission interface 25 to the directional antenna 1, which may adjust an antenna feeding voltage and an antenna feeding phase thereof according to the available excitation voltage and the available excitation phase to generate a corresponding antenna radiation pattern.

Otherwise, if it is determined by the microprocessor 23 that the first signal loss value 232 is greater than the predetermined threshold value, it means that the first signal loss value 232 does not meet the communication quality condition 216. Then, the microprocessor 23 chooses a second excitation parameter set 234 from the excitation parameter set range 214 according to an optimization algorithm, and generates a second signal loss value 236 of the evaluation antenna in the evaluation environment by a ray-tracing method according to the second excitation parameter set 234. Herein, the second signal loss value 236 is also a bit error rate value. In this embodiment, the optimization algorithm is a Genetic Algorithm (GA) or a Particle Swarm Optimization (PSO) algorithm. In other embodiments, the optimization algorithm may be any algorithm used for optimization operation, and this is not intended to limit the present invention. The GA and PSO algorithms may be accomplished through conventional technologies and, thus, will not be further described herein.

Upon generation of the second signal loss value 236, the microprocessor 23 executes a processing procedure identical to that executed on the first signal loss value 232 to determine whether the second signal loss value 236 meets the communication quality condition 216. If no, then the microprocessor 23 further chooses a third excitation parameter set from the excitation parameter set range 214 according to the optimization algorithm. This process proceeds until an excitation parameter set meeting the communication quality condition 216 is chosen.

If it is determined by the microprocessor 23 that the second signal loss value 236 meets the communication quality condition 216, then the second excitation parameter set 234 is set as an available excitation parameter set 230 and is transmitted to the directional antenna 1 via the transmission interface 25 so that the antenna radiation pattern of the directional antenna 1 may be adjusted according to the available excitation parameter set 230.

Apart from determining whether a signal loss value meets the communication quality condition 216 by setting the signal loss value as a bit error rate value, whether the communication quality condition 216 is met may also be determined according to other values in other embodiments. Specifically, in other embodiments, the communication quality condition 216 may also be a predetermined threshold value, and the microprocessor 23 may determine whether a difference 218 between the first signal loss value 232 and the predetermined signal loss value 21b is smaller than or equal to the predetermined threshold value. If the difference 218 is smaller than or equal to the predetermined threshold value, the microprocessor 23 sets the first excitation parameter set 212 as an available excitation parameter set 230 and transmits the available excitation parameter set 230 to the directional antenna 1 via the transmission interface 25 so that the antenna radiation pattern of the directional antenna 1 may be adjusted according to the available excitation parameter set 230.

Otherwise, if the difference 238 is greater than the predetermined threshold value, then the microprocessor 23 chooses a second excitation parameter set 234 from the excitation parameter set range 214 according to an optimization algorithm, and generates a second signal loss value 236 of the evaluation antenna in the evaluation environment by a ray-tracing method according to the second excitation parameter set 234. Next, the microprocessor 23 determines whether a difference 23a between the second signal loss value 236 and the first signal loss value 232 is smaller than or equal to the predetermined threshold value.

If it is determined that the difference 23a is smaller than or equal to the predetermined threshold value, the microprocessor 23 sets the second excitation parameter set 234 as the available excitation parameter set 230 and transmits the available excitation parameter set 230 to the directional antenna 1 via the transmission interface 21 so that the antenna radiation pattern of the directional antenna 1 may be adjusted according to the available excitation parameter set 230.

Otherwise, if it is determined by the microprocessor 23 that the difference 23a is greater than the predetermined threshold value, then the microprocessor 23 continues to generate a difference between a previous signal loss value and the current signal loss value to determine whether the difference is smaller than or equal to the predetermined threshold value. This process proceeds until a difference is smaller than or equal to the predetermined threshold value. Then, the microprocessor 23 sets an excitation parameter set that results in the current signal loss value as the available excitation parameter set 230.

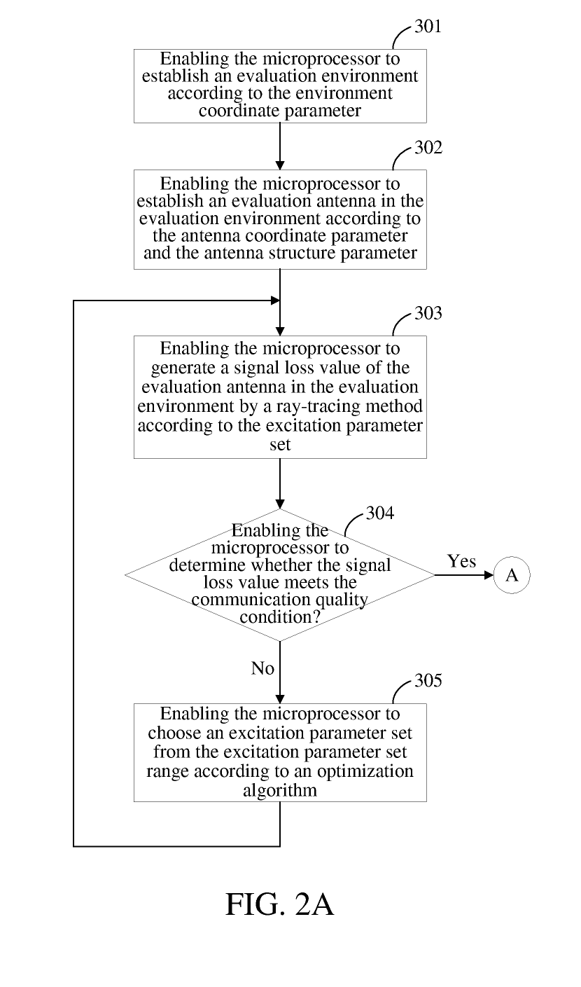

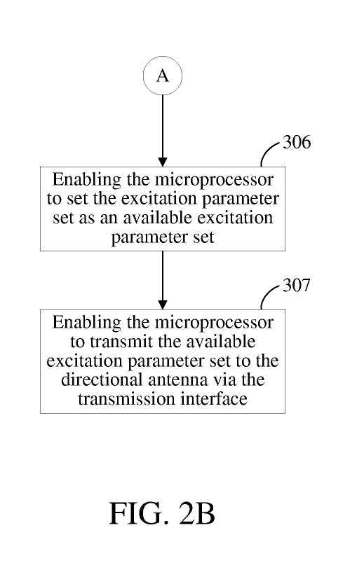

FIGS. 2A-2B show a second example embodiment of the present invention, which is an antenna adjustment method for the antenna adjustment apparatus as described in the first example embodiment. The antenna adjustment apparatus may be used with the directional antenna described in the first example embodiment. In more detail, the antenna adjustment apparatus comprises a transmission interface, a microprocessor and a storage unit. The microprocessor is electrically connected to the transmission interface and the storage unit. The transmission interface is further electrically connected to a directional antenna so that the microprocessor is electrically connected to the directional antenna via the transmission interface.

The storage unit currently stores an environment coordinate parameter of an environment in which the directional antenna is located, an excitation parameter set, an excitation parameter set range, a communication quality condition, an antenna structure parameter of the directional antenna, an antenna coordinate parameter of the directional antenna located in the environment and a predetermined signal loss value.

The antenna adjustment method of the second embodiment may be implemented by a program stored in a tangible machine-readable medium. When the program is loaded into an antenna adjustment apparatus via a computer and a plurality of codes contained therein is executed, the antenna adjustment method of the second embodiment can be accomplished. This tangible machine-readable medium may be a read only memory (ROM), a flash memory, a floppy disk, a hard disk, a compact disk, a mobile disk, a magnetic tape, a database accessible to networks, or any other suitable storage media known to those skilled in the art.

The antenna adjustment method of the second example embodiment comprises the following steps. Referring firstly to FIG. 2A, step 301 is executed to enable the microprocessor to establish an evaluation environment according to the environment coordinate parameter. Specifically, the environment coordinate parameter is a coordinate parameter of a real outdoor environment which comprises coordinate parameters of buildings, trees, signboards or the like, and the evaluation environment is a 2.5D environment.

Then, step 302 is executed to enable the microprocessor to establish an evaluation antenna in the evaluation environment according to the antenna coordinate parameter and the antenna structure parameter. The antenna coordinate parameter is a position coordinate parameter of an array antenna in the outdoor environment, and the antenna structure parameter is an array antenna structure parameter. In this embodiment, the array antenna structure may be one of an O-shaped array antenna, a Y-shaped array antenna and an L-shaped array antenna; however, the array antenna structure may also be of other different structures in other embodiments, and this is not intended to limit the present invention.

Next, step 303 is executed to enable the microprocessor to generate a signal loss value of the evaluation antenna in the evaluation environment by a ray-tracing method according to the excitation parameter set. In this embodiment, the excitation parameter set comprises an excitation voltage and an excitation phase, the ray-tracing method is a 2.5D ray-tracing method, and the first signal loss value is a path loss value or a bit error rate value. In other embodiments, the first signal loss value may also be any value adapted to evaluate the extent of signal loss, and this is not intended to limit the present invention.

Then, step 304 is executed to enable the microprocessor to determine whether the signal loss value meets the communication quality condition. If no, step 305 is executed to enable the microprocessor to choose an excitation parameter set from the excitation parameter set range according to an optimization algorithm. Here, the optimization algorithm is a Genetic Algorithm (GA) or a Particle Swarm Optimization (PSO) algorithm. In other embodiments, the optimization algorithm may be any algorithm used for optimization operation, and this is not intended to limit the present invention. After the excitation parameter set is chosen in step 305, step 303 and step 304 are iterated until a signal loss value meets the communication quality condition.

Otherwise, if it is determined in step 304 that the signal loss value meets the communication quality condition, then referring to FIG. 2B, step 306 is executed to enable the microprocessor to set the excitation parameter set as an available excitation parameter set, and step 307 is executed to enable the microprocessor to transmit the available excitation parameter set to the directional antenna via the transmission interface so that the antenna radiation pattern of the directional antenna may be adjusted according to the available excitation parameter set.

Taking a case in which the communication quality condition is a predetermined threshold value and the signal loss value is a bit error rate value as an example, upon completion of step 301 and step 302, step 303 is executed to enable the microprocessor to generate a bit error rate value of the evaluation antenna in the evaluation environment by a ray-tracing method according to the excitation parameter set.

Next, step 304 is executed to enable the microprocessor to determine whether the signal loss value meets the communication quality condition by determining whether the bit error rate value is smaller than or equal to the predetermined threshold value. If it is determined in step 304 that the bit error rate value is smaller than or equal to the predetermined threshold value, it means that the signal loss value meets the communication quality condition. Then, step 306 is executed to enable the microprocessor to set the excitation parameter set that results in the bit error rate value as an available excitation parameter set, and step 307 is executed to enable the microprocessor to transmit the available excitation parameter set to the directional antenna via the transmission interface so that the antenna radiation pattern of the directional antenna may be adjusted according to the available excitation parameter set.

Otherwise, if it is determined in step 304 that the bit error rate value is greater than the predetermined threshold value, it means that the signal loss value does not meet the communication quality condition. Then, step 305 is executed to enable the microprocessor to choose an excitation parameter set from the excitation parameter set range according to an optimization algorithm, and step 303 is iterated to enable the microprocessor to generate another bit error rate value of the evaluation antenna in the evaluation environment by a ray-tracing method according to the excitation parameter set.

After the another bit error rate value is generated in step 303, step 304 is iterated to enable the microprocessor to determine whether the another bit error rate value is smaller than or equal to the predetermined threshold value. If the another bit error rate value is smaller than or equal to the predetermined threshold value, then step 306 is executed to enable the microprocessor to set the excitation parameter set that results in the another bit error rate value as an available excitation parameter set, and step 307 is executed to enable the microprocessor to transmit the available excitation parameter set to the directional antenna via the transmission interface so that the antenna radiation pattern of the directional antenna may be adjusted according to the available excitation parameter set. Otherwise, if the another bit error rate value is greater than the predetermined threshold value, then step 305 is iterated. In other words, steps 303, 304 and 305 will be iterated continuously until the bit error rate value is smaller than or equal to the predetermined threshold value.

Apart from determining whether a signal loss value meets the communication quality condition according to a bit error rate value, whether the communication quality condition 216 is met may also be determined according to other values in other embodiments. Specifically, it may also be determined in step 304 whether a difference between the current signal loss value and a previous signal loss value is smaller than or equal to the predetermined threshold value. If the difference is smaller than or equal to the predetermined threshold value, step 306 is executed to enable the microprocessor to set the excitation parameter set that results in the current signal loss value as an available excitation parameter set, and step 307 is executed to transmit the available excitation parameter set to the directional antenna via the transmission interface so that the antenna radiation pattern of the directional antenna may be adjusted according to the available excitation parameter set.

Otherwise, if it is determined in step 304 that the difference between the current signal loss value and the previous signal loss value is greater than the predetermined threshold value, then step 305 is iterated to enable the microprocessor to choose a next excitation parameter set from the excitation parameter set range according to an optimization algorithm. Next, step 303 is iterated to enable the microprocessor to generate a next signal loss value of the evaluation antenna in the evaluation environment by a ray-tracing method according to the next excitation parameter set, and step 304 is iterated to enable the microprocessor to determine whether a difference between the current signal loss value and the next signal loss value is smaller than or equal to the predetermined threshold value. In other words, steps 303, 304 and 305 are iterated continuously until a difference between the two signal loss values is smaller than or equal to the predetermined threshold value.

In addition to the aforesaid steps, the second example embodiment may also execute all the operations and functions set forth in the first example embodiment. How the second embodiment executes these operations and functions will be readily appreciated by those of ordinary skill in the art based on the explanation of the first embodiment, and thus will not be further described herein.

Certain embodiments of the present invention may generate an excitation parameter set meeting a communication quality condition according to a real outdoor environment, and set the excitation parameter set as an available excitation parameter set (which may be viewed as a feeding signal) so that the antenna radiation pattern of a directional antenna may be adjusted according to the available excitation parameter set. Thereby, the present invention may provide an optimal antenna excitation parameter set for a base station, and address the drawbacks of the prior art, including that it is impossible to evaluate a real outdoor environment accurately and to provide an optimal antenna radiation pattern for a base station.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An antenna adjustment apparatus, being electrically connected to a directional antenna located in an environment, comprising:
a storage unit, being configured to store an environment coordinate parameter of the environment, a first excitation parameter set, a communication quality condition, an antenna structure parameter of the directional antenna and an antenna coordinate parameter of the directional antenna of the environment; and
a microprocessor, being electrically connected to the storage unit and configured to:
generate a first signal loss value according to the environment coordinate parameter, the antenna coordinate parameter, the first excitation parameter set and the antenna structure parameter;
determine that the first signal loss value meets the communication quality condition; and
set the first excitation parameter set as an available excitation parameter set so that the antenna radiation pattern of the directional antenna may be adjusted according to the available excitation parameter set.

2. The antenna adjustment apparatus as claimed in claim 1, wherein the microprocessor is further configured to:
establish an evaluation environment according to the environment coordinate parameter;
establish an evaluation antenna in the evaluation environment according to the antenna coordinate parameter and the antenna structure parameter; and
generate the first signal loss value of the evaluation antenna in the evaluation environment by a ray-tracing method according to the first excitation parameter set.

3. The antenna adjustment apparatus as claimed in claim 2, further comprising a transmission interface electrically connected to the microprocessor and the directional antenna, wherein the storage unit is further configured to store an excitation parameter set range, and the microprocessor is further configured to:
determine that the first signal loss value does not meet the communication quality condition;
choose a second excitation parameter set from the excitation parameter set range;
generate a second signal loss value of the evaluation antenna in the evaluation environment by the ray-tracing method according to the second excitation parameter set;
determine that the second signal loss value meets the communication quality condition;
set the second excitation parameter set as the available excitation parameter set; and
transmit the available excitation parameter set to the directional antenna via the transmission interface so that the antenna radiation pattern of the directional antenna may be adjusted according to the available excitation parameter set.

4. The antenna adjustment apparatus as claimed in claim 3, wherein the microprocessor is configured to choose the second excitation parameter set from the excitation parameter set range according to an optimization algorithm.

5. The antenna adjustment apparatus as claimed in claim 2, further comprising a transmission interface being electrically connected to the microprocessor and the directional antenna, wherein the storage unit is further configured to store an excitation parameter set range and a predetermined signal loss value, and the microprocessor is further configured to:
determine that a difference between the first signal loss value and the predetermined signal loss value does not meet the communication quality condition;
choose a second excitation parameter set from the excitation parameter set range;
generate a second signal loss value of the evaluation antenna in the evaluation environment by the ray-tracing method according to the second excitation parameter set;
determine that a difference between the second signal loss value and the first signal loss value meets the communication quality condition;
set the second excitation parameter set as the available excitation parameter set; and
transmit the available excitation parameter set to the directional antenna via the transmission interface so that the antenna radiation pattern of the directional antenna may be adjusted according to the available excitation parameter set.

6. The antenna adjustment apparatus as claimed in claim 5, wherein the microprocessor is configured to choose the second excitation parameter set from the excitation parameter set range according to an optimization algorithm.

7. An antenna adjustment method for use in an antenna adjustment apparatus, the antenna adjustment apparatus being electrically connected to a directional antenna located in an environment and comprising a storage unit and a microprocessor, the microprocessor being electrically connected to the storage unit, the storage unit being configured to store an environment coordinate parameter of the environment, a first excitation parameter set, a communication quality condition, an antenna structure parameter of the directional antenna and an antenna coordinate parameter of the directional antenna of the environment, the antenna adjustment method comprising the steps of:
(a) enabling the microprocessor to generate a first signal loss value according to the environment coordinate parameter, the antenna coordinate parameter, the first excitation parameter set and the antenna structure parameter;
(b) enabling the microprocessor to determine that the first signal loss value meets the communication quality condition; and
(c) enabling the microprocessor to set the first excitation parameter set as an available excitation parameter set so that the antenna radiation pattern of the directional antenna may be adjusted according to the available excitation parameter set.

8. The antenna adjustment method as claimed in claim 7, wherein the step (a) comprises the steps of:
enabling the microprocessor to establish an evaluation environment according to the environment coordinate parameter;
enabling the microprocessor to establish an evaluation antenna in the evaluation environment according to the antenna coordinate parameter and the antenna structure parameter; and
enabling the microprocessor to generate the first signal loss value of the evaluation antenna in the evaluation environment by a ray-tracing method according to the first excitation parameter set.

9. The antenna adjustment method as claimed in claim 8, wherein the antenna adjustment apparatus further comprises a transmission interface electrically connected to the microprocessor and the directional antenna, and the storage unit is further configured to store an excitation parameter set range, the antenna adjustment method further comprises the steps of:
(d) enabling the microprocessor to determine that the first signal loss value does not meet the communication quality condition;
(e) enabling the microprocessor to choose a second excitation parameter set from the excitation parameter set range;
(f) enabling the microprocessor to generate a second signal loss value of the evaluation antenna in the evaluation environment by the ray-tracing method according to the second excitation parameter set;
(g) enabling the microprocessor to determine that the second signal loss value meets the communication quality condition;
(h) enabling the microprocessor to set the second excitation parameter set as the available excitation parameter set; and
(i) enabling the microprocessor to transmit the available excitation parameter set to the directional antenna via the transmission interface so that the antenna radiation pattern of the directional antenna may be adjusted according to the available excitation parameter set.

10. The antenna adjustment method as claimed in claim 9, wherein the microprocessor is configured to choose the second excitation parameter set from the excitation parameter set range according to an optimization algorithm.

11. The antenna adjustment method as claimed in claim 8, wherein the antenna adjustment apparatus further comprises a transmission interface being electrically connected to the microprocessor and the directional antenna, and the storage unit is further configured to store an excitation parameter set range and a predetermined signal loss value, the antenna adjustment method further comprising the steps of:
(d) enabling the microprocessor to determine that a difference between the first signal loss value and the predetermined signal loss value does not meet the communication quality condition;
(e) enabling the microprocessor to choose a second excitation parameter set from the excitation parameter set range;
(f) enabling the microprocessor to generate a second signal loss value of the evaluation antenna in the evaluation environment by the ray-tracing method according to the second excitation parameter set;
(g) enabling the microprocessor to determine that a difference between the second signal loss value and the first signal loss value meets the communication quality condition;
(h) enabling the microprocessor to set the second excitation parameter set as the available excitation parameter set; and
(i) enabling the microprocessor to transmit the available excitation parameter set to the directional antenna via the transmission interface so that the antenna radiation pattern of the directional antenna may be adjusted according to the available excitation parameter set.

12. The antenna adjustment method as claimed in claim 11, wherein the microprocessor is configured to choose the second excitation parameter set from the excitation parameter set range according to an optimization algorithm.

13. A tangible machine-readable medium, storing a program of an antenna adjustment method for use in an antenna adjustment apparatus, the antenna adjustment apparatus being electrically connected to a directional antenna located in an environment and comprising a storage unit and a microprocessor, the microprocessor being electrically connected to the storage unit, and the storage unit being configured to store an environment coordinate parameter of the environment, a first excitation parameter set, a communication quality condition, an antenna structure parameter of the directional antenna and an antenna coordinate parameter of the directional antenna located in the environment, the program being loaded into the antenna adjustment apparatus and then executing:
a code A for enabling the microprocessor to generate a first signal loss value according to the environment coordinate parameter, the antenna coordinate parameter, the first excitation parameter set and the antenna structure parameter;
a code B for enabling the microprocessor to determine that the first signal loss value meets the communication quality condition; and
a code C for enabling the microprocessor to set the first excitation parameter set as an available excitation parameter set so that the antenna radiation pattern of the directional antenna may be adjusted according to the available excitation parameter set.

14. The tangible machine-readable medium as claimed in claim 13, wherein the code A comprises the following codes:
a code A1 for enabling the microprocessor to establish an evaluation environment according to the environment coordinate parameter;
a code A2 for enabling the microprocessor to establish an evaluation antenna in the evaluation environment according to the antenna coordinate parameter and the antenna structure parameter; and
a code A3 for enabling the microprocessor to generate the first signal loss value of the evaluation antenna in the evaluation environment by a ray-tracing method according to the first excitation parameter set.

15. The tangible machine-readable medium as claimed in claim 14, wherein the antenna adjustment apparatus further comprises a transmission interface electrically connected to the microprocessor and the directional antenna, and the storage unit is further configured to store an excitation parameter set range, and wherein when being loaded into the antenna adjustment apparatus, the program further executes:
a code D for enabling the microprocessor to determine that the first signal loss value does not meet the communication quality condition;
a code E for enabling the microprocessor to choose a second excitation parameter set from the excitation parameter set range;
a code F for enabling the microprocessor to generate a second signal loss value of the evaluation antenna in the evaluation environment by the ray-tracing method according to the second excitation parameter set;
a code G for enabling the microprocessor to determine that the second signal loss value meets the communication quality condition;
a code H for enabling the microprocessor to set the second excitation parameter set as the available excitation parameter set; and
a code I for enabling the microprocessor to transmit the available excitation parameter set to the directional antenna via the transmission interface so that the antenna radiation pattern of the directional antenna may be adjusted according to the available excitation parameter set.

16. The tangible machine-readable medium as claimed in claim 15, wherein the microprocessor is configured to choose the second excitation parameter set from the excitation parameter set range according to an optimization algorithm.

17. The tangible machine-readable medium as claimed in claim 14, wherein the antenna adjustment apparatus further comprises a transmission interface being electrically connected to the microprocessor and the directional antenna, and the storage unit is further configured to store an excitation parameter set range and a predetermined signal loss value, and wherein when being loaded into the antenna adjustment apparatus, the program further executes:
a code D for enabling the microprocessor to determine that a difference between the first signal loss value and the predetermined signal loss value does not meet the communication quality condition;
a code E for enabling the microprocessor to choose a second excitation parameter set from the excitation parameter set range;
a code F for enabling the microprocessor to generate a second signal loss value of the evaluation antenna in the evaluation environment by the ray-tracing method according to the second excitation parameter set;
a code G for enabling the microprocessor to determine that a difference between the second signal loss value and the first signal loss value meets the communication quality condition;
a code H for enabling the microprocessor to set the second excitation parameter set as the available excitation parameter set; and
a code I for enabling the microprocessor to transmit the available excitation parameter set to the directional antenna via the transmission interface so that the antenna radiation pattern of the directional antenna may be adjusted according to the available excitation parameter set.

18. The tangible machine-readable medium as claimed in claim 17, wherein the microprocessor is configured to choose the second excitation parameter set from the excitation parameter set range according to an optimization algorithm.
